(19) United States
(12) Patent Application Publication
(10) Pub. No.: US 2013/0176292 A1
(43) Pub. Date: Jul. 11, 2013

(54) ULTRA-BRIGHT BACK-LIGHT LCD VIDEO DISPLAY

(71) Applicant: Kenneth LI, Castaic, CA (US)

(72) Inventor: Kenneth LI, Castaic, CA (US)

(21) Appl. No.: 13/737,282

(22) Filed: Jan. 9, 2013

Related U.S. Application Data
(60) Provisional application No. 61/584,481, filed on Jan. 9, 2012.

(51) Int. Cl. G02F 1/1335; G09G 3/00

(52) U.S. Cl. CPC G02F 1/133606; G09G 3/001
USPC 345/207; 349/58

(57) ABSTRACT

An ultra-bright back-light LCD video display comprises a housing containing a light source such as one or more LEDs. A collimating lens receives substantially all of the light generated by said light source, and directs such light through a polarizer. The polarizer output is sent to an LCD panel having an array of pixels dynamically controlled to permit light to pass through predetermined pixels. The LCD panel output passes through a diffuser forming a video image screen.

### CROSS-REFERENCE TO RELATED APPLICATIONS

The present application claims priority on U.S. provisional application No. 61/584,481, filed on Jan. 9, 2012.

### BACKGROUND OF THE INVENTION

Outdoor video displays commonly use LEDs, which provide brightness at the expense of resolution. However, traditional and outdoor LDC displays are usually not a bright as would be desired, providing a luminance only in the range of about 400 to 1,200 candela per square meter (also referred to as “nits”).

It would thus be desirable to provide a display unit, for example as a video cube, which would provide greater brightness but still using LEDs.

### SUMMARY OF THE INVENTION

An ultra-bright back-light LCD video display comprises a housing containing a light source such as one or more LEDs. A collimating lens receives substantially all of the light generated by said light source, and directs such light through a polarizer. The polarizer output is sent to an LCD panel having an array of pixels dynamically controlled to permit light to pass through predetermined pixels. The LCD panel output passes through a diffuser forming a video image screen.

Optionally, a recycling collar may be positioned about the LED, within the video display housing, to capture more light. Alternately, a parabolic reflector may be positioned about the LED to capture more light. An additional lens may be positioned between the light source and collimating lens if desired.

In another embodiment, a light tunnel, with a reflective interior surface, is provided between the collimating lens and the screen.

One or more light sensors may be positioned within the housing, and control circuitry, using the output of such light sensors as well as an external calibration sensor, are used to adjust the image color and uniformity.

Multiple light sources may be used, particularly where needed for larger screens. Also, multiple video displays may be stacked to form a video wall. In either case, the control circuitry is used, together with the sensors, to adjust the image color and intensity such that the screen display is uniform.

### BRIEF DESCRIPTION OF THE DRAWINGS

FIG. 1 is a schematic representation of a first embodiment of an LCD backlight system according to the invention;

FIG. 2 is a schematic representation of a second embodiment of an LCD backlight system according to the invention;

FIG. 3 is a schematic representation of an embodiment of a light source for use in an LCD backlight system;

FIG. 4 is a schematic representation of a third embodiment of an LCD backlight system according to the invention;

FIG. 5 is a schematic representation of a modification of the system which may be used with the prior embodiments;

FIG. 6 is a schematic representation of another embodiment of a portion of an LCD backlight system according to the invention;

FIG. 7 is a perspective view of a display model according to the invention;

FIG. 8 is a perspective view of a video wall formed with a plurality of the modules of FIG. 7;

FIG. 9 is a schematic representation of a control module for use in the system of the invention; and

FIG. 10 is a schematic representation of an LCD backlight system using a plurality of light sources.

### DETAILED DESCRIPTION OF THE INVENTION

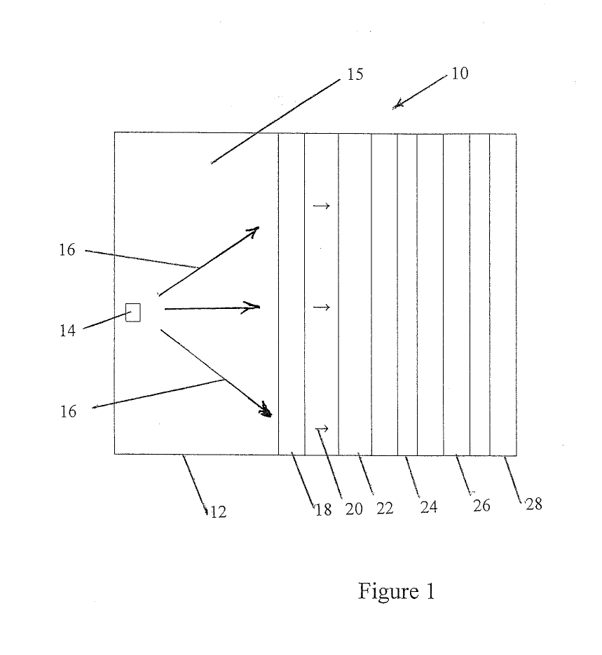

FIG. 1 shows a first embodiment of a video display 10 having a housing 12. A light source, which is preferably an LED 14, is secured in a first, open chamber 15 within the housing 12 and energized by a power supply (not shown). Light 16 emitted from the LED is collimated by a lens 18, which closes off the chamber 15. The collimated light 20 is passed through a polarizer 22, which may be either absorptive or reflective. When a reflective polarizer is used, light which does not pass through the polarizer 22 is reflected back to the LED and will be recycled, enhancing the output of the system.

The polarized light is then passed through an LCD panel 24 and a second polarizer 26 (analyzer), which will allow light from modulated pixels on the LCD panel 24 to pass through and be seen.

The output from the second polarizer 26 will have a narrow divergence and a very narrow viewing angle. To create a wider viewing angle, the light is passed through a diffuser 28. The brightness of the screen will be dependent on the power of the light source. In the FIG. 1 example, the lens 18, polarizers 22 and 26, LCD panel 24, and diffuser 28 are all contained within the housing 12 and spaced apart from one another by an air gap.

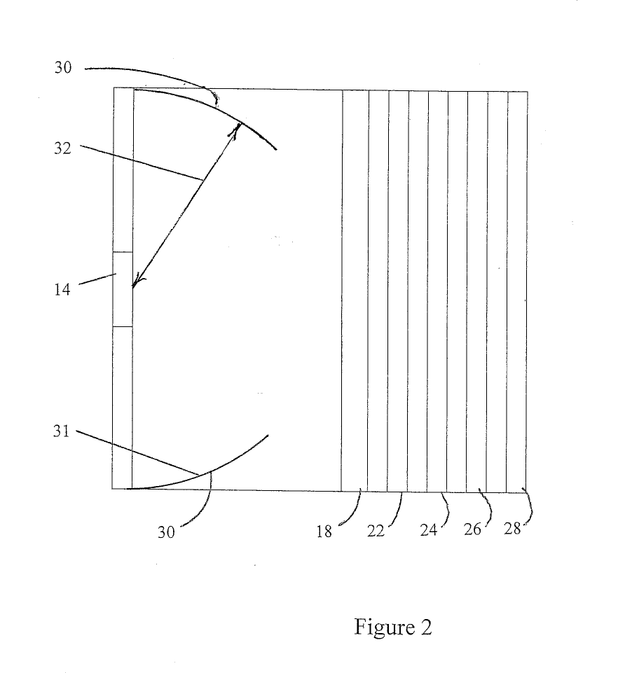

LEDs emit light at very large angles, and it is thus difficult to collect the light output. FIG. 2 shows an alternate embodiment in which the video display 10a contains a recycling collar 30, with an internal reflecting surface 31, within the housing between the LED 14 and the collimating lens 18. In the FIG. 2 embodiment, light emitted from the LED 14 which is low angle will be emitted directly to the lens 18, whereas beams 32 having an emission angle which is higher than a predetermined angle will reflect off the recycling collar inner surface 32 back towards the LED 14. Thus, all of the high angle beams 32 will be recycled.

In most applications, the collimating lens, polarizers, LCD panel, and the screen are rectangular. Thus, the aperture which light exits the video display 10, 10a should be rectangular in shape to match the screen.

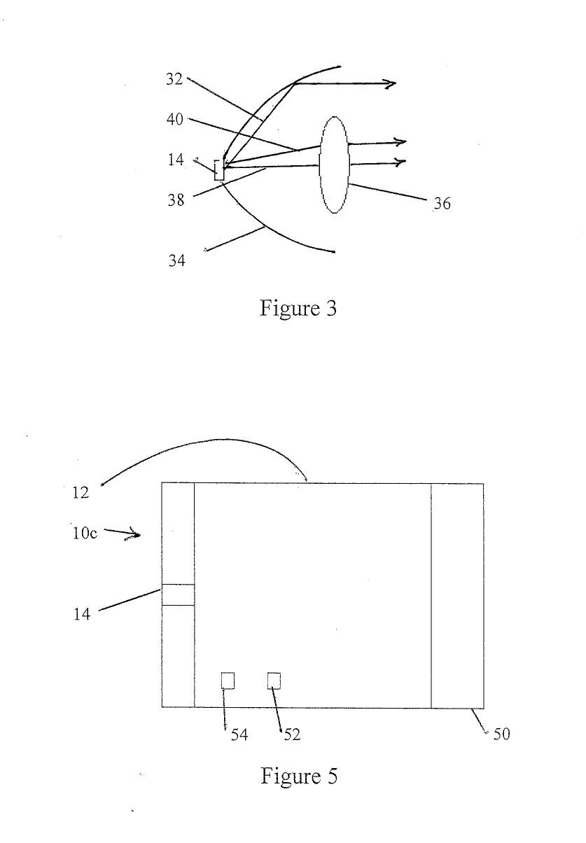

In the embodiment of FIG. 3, instead of having a recycling collar 30 within the housing interior 15 and a collimating lens 18 collecting all of the light, a paraboloid reflector 34 surrounds the LED 14 to collect the high angle beams and collimate them. A smaller collimating lens 36 is disposed in the chamber 12 and centered along the axis 38 of the display to capture and collimate only the small angle beams 40. The higher angle beams 32, after being collimated by the paraboloid reflector 34, pass to the outside of the lens 36 toward the polarizer 22. The configuration shown in FIG. 3 provides a high output, but with higher divergence after collimation by the collimating lens. The higher divergence will result in a lower contrast ratio from the LCD display.

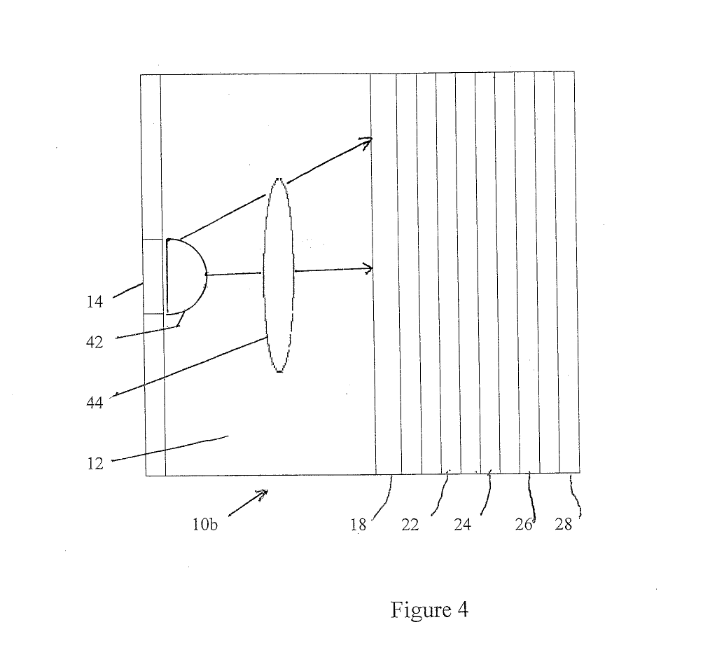

In the embodiment of FIG. 4, the video display 10b includes a dome lens 42 mounted over the LED 14, which improves the efficiency of the system. Optionally, a lens 44 may be located in the chamber 12 so that the light from the dome is coupled to the collimating lens 18 efficiently.

FIG. 5 shows a display module 10c including a light source 14 and a screen 50, which includes a collimating lens, an LCD with polarizers, diffusers, reflectors, etc. The module 10c also includes within the interior or the housing light sensors 52 and control circuitry 54. The control circuits 54 contain information of the intensity of the light source, intensity of various colors, and uniformity of the light illumination at the screen, such that the input image signal can be adjusted to provide the desired image color and uniformity.

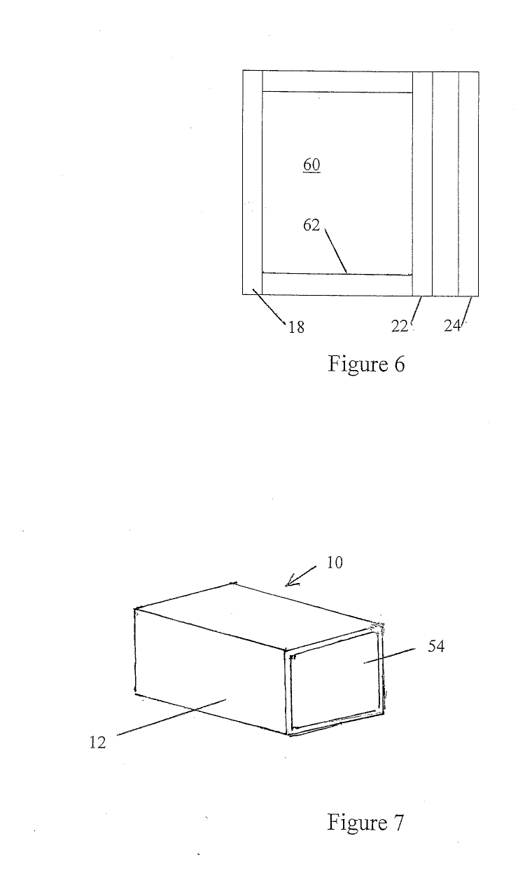

FIG. 6 shows a portion of an alternative embodiment of an LCD video display. A hollow chamber 60 between the collimating lens 18 and polarizer 22 or LCD panel 24 which is completely enclosed in a reflective wall 62, producing a higher uniformity of illumination.

FIG. 7 shows a perspective view of an LCD video display 10 with the LCD and a rectangular screen 54.

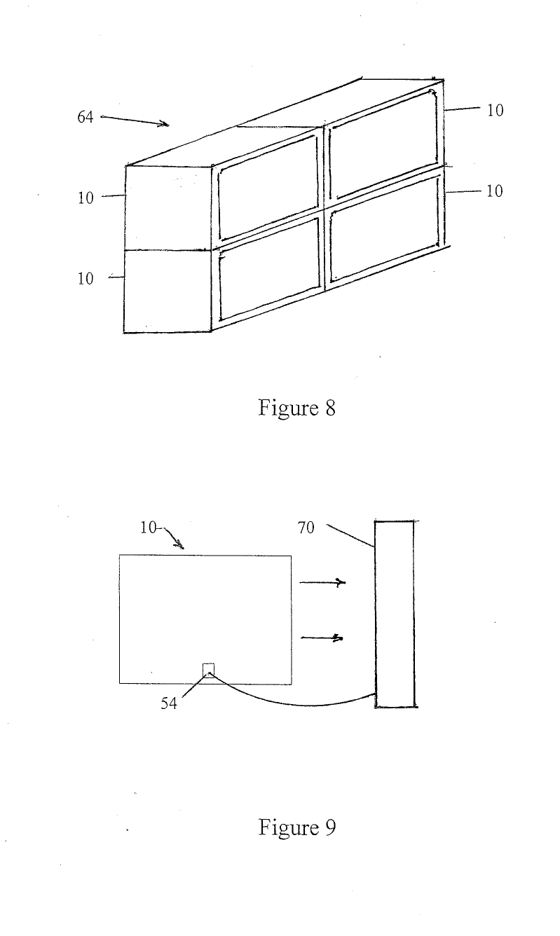

FIG. 8 shows a video wall 64 formed by a 2×2 configuration of stacked video displays 10.

FIG. 9 shows a video display 10 containing a control circuitry 54 which is connected to an external calibration sensor module 70. The control circuit receives input signals from both the external sensor module 70 as well as the internal sensor 52 shown in FIG. 5. Test images are used such that the intensity, colors, and distortions if any are detected by the calibration sensor module 70 and the adjustment parameters are sent and stored in the control circuitry 54. This is particularly important when multiple units are put together as a video wall.

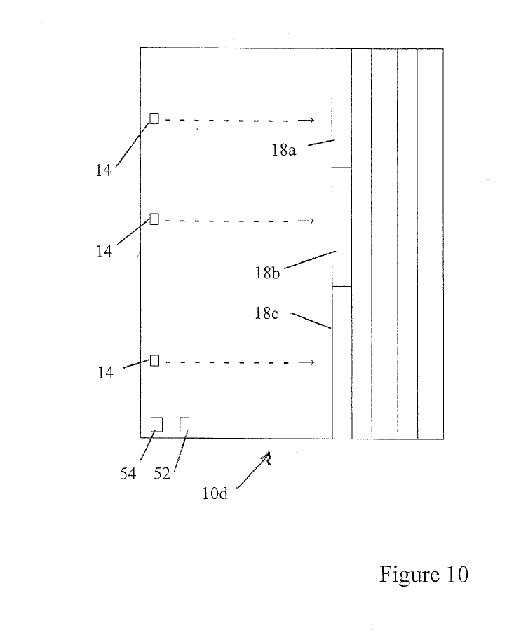

FIG. 10 shows a LCD video display 10d containing multiple light sources 14, which may be used to illuminate larger LCD panels. For example, a 10″ diagonal display can be powered by a single LED light source. A 60″ diagonal display is preferably powered by 9 LED light sources which are spaced apart within the interior chamber 12 in 3×3 configuration. In place of a single collimating lens 18, preferably a separate collimating lens 18a, 18b, and 18c is used with each light source 14.

Since each of the light sources 14 will have a slightly different intensity and color, the output from the sensors will be used to make adjustments using the control circuitry 54. In addition, the calibration sensor module 70 can also be used, as shown in FIG. 9, such that the large screen size will have a uniform intensity and colors. The reflector chamber 60 and walls 62, shown in FIG. 6, which form a light tunnel between the collimating lens 18 and the screen, may also be used in this embodiment.

The collimating lens can be a glass lens, a plastic lens, or Fresnel lens. The light source 14, while preferably an LED, may instead be an arc lamp, microwave lamp, or halogen lamp. The calibration module 70 includes a digital camera and a computer for analysis, which computer is connected to the control circuitry 54 and provides adjustment parameters. The adjustment parameter are stored in the control circuitry memory.

The foregoing description represents the preferred embodiments of the invention. Various modifications will be apparent to persons skilled in the art. All such modifications and variations are intended to be within the scope of the invention, as set forth in the following claims.

1. An ultra-bright back-light LCD video display comprising:
a housing having a hollow chamber containing a light source;
a collimating lens contained in said housing to receive substantially all of the light generated by said light source;
a polarizer coupled to said collimating lens in a manner as to receive substantially all of the light passing through said collimated lens;
an LCD panel coupled to said polarizer in such a manner as to receive substantially all of the light passing through said polarizer, said LCD panel having an array of pixels dynamically controlled to permit light to pass through predetermined pixels; and
a diffuser coupled to said LCD panel in such a manner as to receive substantially all of the light passing through said LCD panel and to form a video image screen.

2. The video display of claim 1, further comprising a recycling collar positioned about the LED, within the video display housing, to capture more light.

3. The video display of claim 1, further comprising a parabolic reflector may be positioned about the LED to capture more light.

4. The video display of claim 1, comprising an additional lens positioned between the light source and collimating lens.

5. The video display of claim 1, further comprising a light tunnel, with a reflective interior surface, positioned between the collimating lens and the screen.

6. The video display of claim 1, wherein said housing contains one or more light sensors and control circuitry which uses the output of such light sensors, as well as an external calibration sensor, to adjust the image color and uniformity.

7. The video display of claim 1, wherein said housing contains multiple light sources, and comprising control circuitry which, using internal and external sensors, adjusts the screen display such that the image color and intensity are uniform.

8. The video display of claim 7, comprising a separate collimating lens for each light source.

9. A video wall comprising multiple, stacked video displays as recited in claim 1.

10. A video wall as recited in claim 9, further comprising control circuitry which, using internal and external sensors, adjusts the image color and intensity such that the screen display of the video wall is uniform.
